(19) United States
(12) Patent Application Publication
(10) Pub. No.: US 2022/0135034 A1
(43) Pub. Date: May 5, 2022

(54) TRAVELING CONTROL DEVICE, TRAVELING CONTROL PROGRAM, AND TRAVELING CONTROL SYSTEM

(71) Applicant: TOYOTA JIDOSHA KABUSHIKI KAISHA, Toyota-shi (JP)

(72) Inventors: Masaki ITO, Toyota-shi (JP); Yuki TAKAHASHI, Susono-shi (JP); Sakiko YOSHIDA, Mishima-shi (JP); Kizuku YAMADA, Susono-shi (JP); Yoshimasa WATANABE, Sunto-gun (JP); Tomonori IMAMURA, Nagoya-shi (JP)

(73) Assignee: TOYOTA JIDOSHA KABUSHIKI KAISHA, Toyota-shi (JP)

(21) Appl. No.: 17/469,370

(22) Filed: Sep. 8, 2021

(30) Foreign Application Priority Data
Nov. 5, 2020 (JP) 2020-185109

(51) Int. Cl. B60W 30/18; H04W 4/40; G06F 1/3206

(52) U.S. Cl. CPC B60W 30/18; H04W 4/40; B60W 2510/0638; B60W 2552/53; G06F 1/3206

(57) ABSTRACT

A traveling control device according to the present disclosure includes a processor that cancels a designation of type a vehicle that travels in each of a plurality of traveling lanes in which the vehicle travels in the same direction and for which the type of the vehicle that travels in each of the traveling lanes is designated, when information relating a disaster is acquired.

### CROSS-REFERENCE TO RELATED APPLICATION

This application claims priority to Japanese Patent Application No. 2020-185109 filed on Nov. 5, 2020, incorporated herein by reference in its entirety.

### BACKGROUND

### 1. Technical Field

The present disclosure relates to a traveling control device, a traveling control program, and a traveling control system.

### 2. Description of Related Art

Japanese Unexamined Patent Application Publication No. 2019-008339 (JP 2019-008339 A) discloses that a power supply facility is controlled such that, in the event of a disaster, an emergency vehicle can preferentially use the power supply facility among vehicles capable of traveling in a hybrid traveling mode or an electric vehicle (EV) traveling mode.

### SUMMARY

In a traveling lane for which the type of vehicle that can travel is designated, when the traveling lane is damaged in the event of a disaster and the damaged lane is a lane in which an emergency vehicle or the like travels, the emergency vehicle may not be able to move, and goods may not be able to be transported.

The present disclosure has been made in view of the above, and an object of the present disclosure is to provide a traveling control device, a traveling control program, and a traveling control system capable of maintaining traveling of an emergency vehicle in the event of a disaster or the like.

A traveling control device according to the present disclosure includes a processor that cancels designation of a type of a vehicle that travels in each of a plurality of traveling lanes in which the vehicle travels in the same direction and for which the type of the vehicle that travels in each of the traveling lanes is designated, when information related to a disaster is acquired.

Further, a traveling control program according to the present disclosure causes

a processor to execute cancellation of a designation of a type of a vehicle that travels in each of a plurality of traveling lanes in which the vehicle travels in the same direction and for which the type of the vehicle that travels in each of the traveling lanes is designated, when information related to a disaster is acquired.

Further, a traveling control system according to the present disclosure includes:

a plurality of traveling lanes in which a vehicle travels in the same direction and for which a type of the vehicle that travels in each of the traveling lanes is designated; and a traveling control device including a first processor that cancels, for the traveling lanes, the designation of the type of the vehicle traveling in each of the traveling lanes when information related to a disaster is acquired.

According to the present disclosure, it is possible to maintain traveling of an emergency vehicle in the event of a disaster or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a traveling control system according to an embodiment;

FIG. 2 is a block diagram illustrating the configuration of a vehicle (vehicle control device) according to the embodiment;

FIG. 3 is a diagram showing an example of the vehicle and a traveling lane in the traveling control system according to the embodiment;

FIG. 4 is a sequence diagram illustrating a traveling control process executed by the traveling control system according to the embodiment;

FIG. 5 is a diagram showing an example of a mode of controlling the traveling lanes in the event of a disaster in the traveling control system according to the embodiment; and

FIG. 6 is a schematic view showing a traveling control system according to a modification.

### DETAILED DESCRIPTION OF EMBODIMENTS

Hereinafter, an embodiment of the present disclosure will be described below with reference to the drawings. In all the drawings of the following embodiment, the same or corresponding portions are designated by the same reference signs. Further, the present disclosure is not limited to the embodiments described below.

### EMBODIMENT

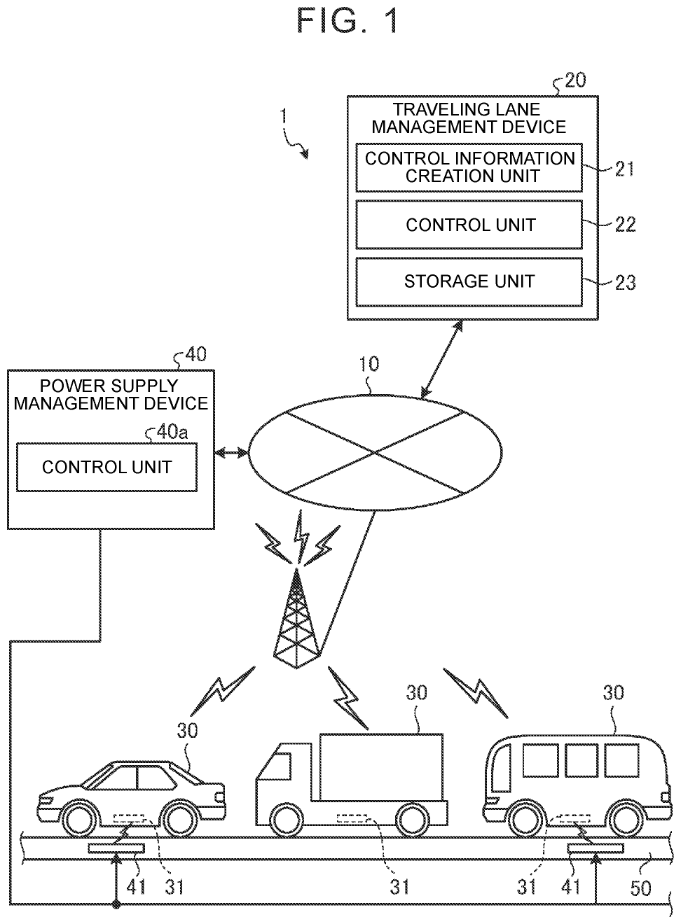

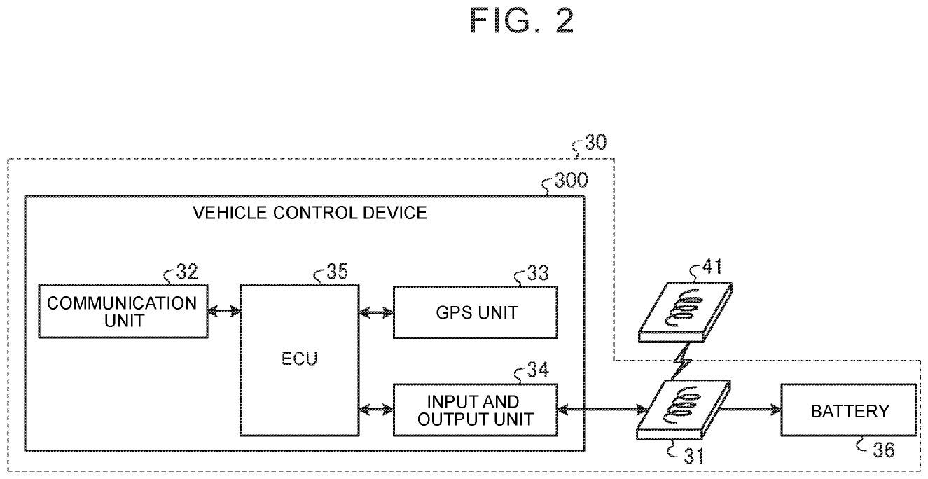

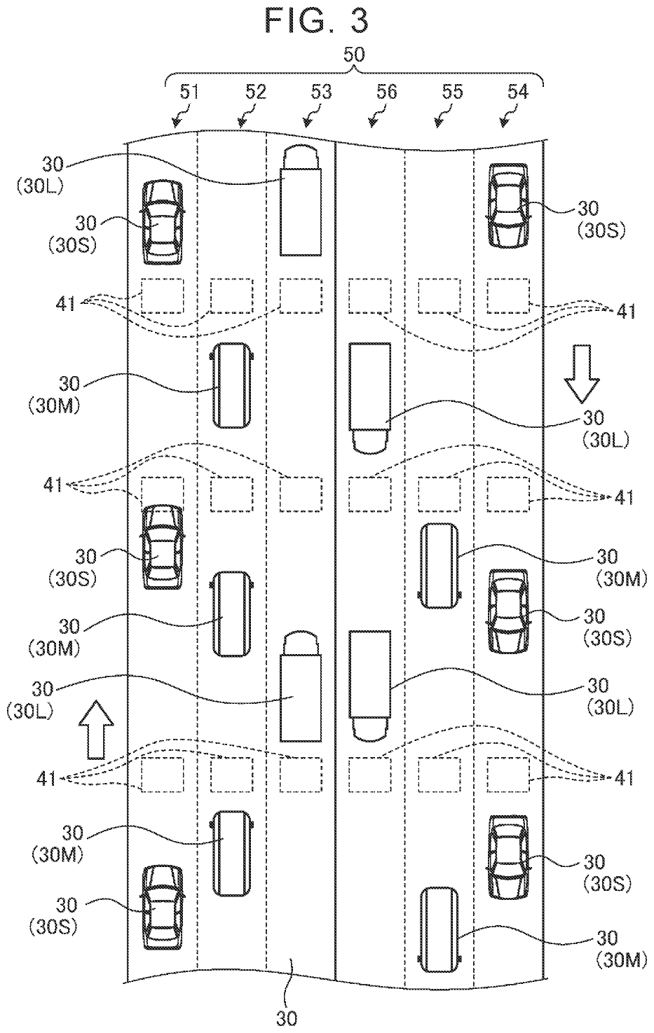

First, a traveling control system according to an embodiment will be described. FIG. 1 is a schematic view showing a traveling control system including a power supply management device according to the embodiment. FIG. 2 is a block diagram illustrating the configuration of a vehicle (vehicle control device) according to the embodiment. FIG. 3 is a diagram showing an example of the vehicle and a traveling lane in the traveling control system according to the embodiment.

As shown in FIG. 1, a traveling control system 1 according to the embodiment includes a traveling lane management device 20, a vehicle 30, and a power supply management device 40. In the traveling control system 1 according to the embodiment, the traveling lane management device 20, each vehicle 30, and the power supply management device 40 are connected to each other by a network 10 so as to be communicable with each other. The network 10 is composed of an Internet line network, a mobile phone line network, and the like by which the traveling lane management device 20, the vehicle 30, and the power supply management device 40 are communicable with each other. In the present embodiment, the vehicle 30 is assumed to be a vehicle capable of traveling in a hybrid traveling mode or an EV traveling mode. The vehicle 30 is charged with electric power supplied from a power supply device 41 managed by the power supply management device 40.

The traveling lane management device 20 controls formation of the vehicles 30 traveling in the traveling lane, and transmits information for controlling a power supply mode in the traveling lane to the power supply management device 40. The traveling lane management device 20 includes a control information creation unit 21, a control unit 22, and a storage unit 23. The traveling lane management device 20 is configured using one or a plurality of computers including a central processing unit (CPU), a field programmable gate array (FPGA), a read only memory (ROM), a random access memory (RAM), and the like. The traveling lane management device 20 corresponds to a traveling control device.

The control information creation unit 21 creates traveling lane control information for controlling power supply in the traveling lane based on the received information related to a disaster.

The control unit 22 comprehensively controls an operation of each unit of the traveling lane management device 20. Further, the control unit 22 controls traveling of the vehicle 30. The control unit 22 controls the traveling lane in which each vehicle 30 travels and a traveling speed at which each vehicle 30 travels in accordance with the type of the vehicle 30. In the present embodiment, the type of vehicle traveling in the traveling lane is usually regulated under the control of the control unit 22. For example, the traveling lane in which each type of vehicle 30 travels is regulated in accordance with the degree of emergency. The emergency increases as the public nature of medical care, transportation of goods, etc. increases.

The storage unit 23 is configured using a computer-readable recording medium, and various programs and various data are stored in a writable and readable manner. The recording medium includes a storage medium such as an optical disk, a flash memory, and a magnetic disk, and a drive device for these storage media.

Further, the storage unit 23 stores power supply control information used when the control information creation unit 21 creates the control information. The power supply control information includes a power supply ratio corresponding to the type of control assigned to each traveling lane when the type of vehicle is designated for the traveling lane or the designation is canceled. The power supply ratio is determined, for example, in accordance with a magnitude relationship of the supplied power corresponding to the size of the traveling vehicle 30. The power supply ratio is set such that the power supplied by the power supply device 41 becomes larger as the size of the traveling vehicle 30 in the traveling lane becomes larger.

In the present embodiment, non-contact charging is performed between the vehicle 30 and the power supply device 41. A receiving unit 31 provided in the vehicle 30 communicates with the power supply device 41 connecting to the power supply management device 40 so as to transmit a power supply signal to the vehicle 30. The receiving unit 31 and the power supply device 41 are each configured using, for example, a coil, a switching circuit, and a rectifying and smoothing circuit, and transmit and receive the power supply signal by a magnetic field resonance method. With this configuration, the vehicle 30 and the power supply device 41 communicate with each other in a non-contact state. The power supply device 41 preferably extends along the traveling lane in order to lengthen a power supply section. In the present embodiment, an example in which electric power is supplied and information is transmitted using electromagnetic waves will be described. However, a configuration in which electric power is supplied and information is transmitted using light may be adopted. Further, the receiving unit 31 may not accept an input of the power supply signal when the remaining charge of the battery of the vehicle 30 has reached the upper limit value. The remaining charge is, for example, a state of charge (SOC).

The power supply device 41 is provided in a plurality of lanes (traveling lanes) in which the vehicle travels, and is electrically connected to the power supply management device 40. Further, in the present embodiment, the power supply device 41 may have a detection function that detects the vehicle 30 located on the power supply device 41 and a reception function that receives information on the vehicle 30. The detection function and reception function are configured using, for example, a loop antenna. For example, the detection function transmits a detection signal to the power supply management device 40 when the vehicle 30 is detected. Note that, when the vehicle can be detected by a power supply coil or the like, the coil may be used for detection in common with power supply.

Subsequently, the configuration of the vehicle 30 will be described with reference to FIG. 2. The vehicle 30 includes a receiving unit 31, a communication unit 32, a global positioning system (GPS) unit 33, an input and output unit 34, and an electronic control unit (ECU) 35. Further, the vehicle 30 is provided with a battery 36 that supplies electric power to each portion. The battery 36 is configured to be rechargeable. In the present embodiment, a vehicle control device 300 is configured by the communication unit 32, the GPS unit 33, the input and output unit 34, and the ECU 35. The vehicle control device 300 is configured using one or a plurality of computers including a CPU, FPGA, ROM, RAM, and the like.

The receiving unit 31 receives the power supply signal from the power supply device 41. The receiving unit 31 may be configured to acquire energy from the power supply device 41 such as light, or may transmit its own information to the power supply device 41 using the electromagnetic wave. The receiving unit, the acquiring unit, and the transmitting unit may be provided separately instead of being integrated. The power supply signal received by the receiving unit 31 is supplied to the battery 36 as electric power.

The communication unit 32 communicates with the traveling lane management device 20 by wireless communication via the network 10. The communication unit 32 receives the driving support information for supporting driving of the vehicle 30 from the traveling lane management device 20. The driving support information includes driving information related to the traveling lane in which the vehicle 30 travels and a speed at which the vehicle 30 travels, and road traffic information such as regulations and traffic jams. Further, the communication unit 32 may be configured to transmit its own information to the power supply management device 40.

The GPS unit 33 receives radio waves from GPS satellites and detects the position of the vehicle 30. The detected position is output to the outside (traveling lane management device 20) or stored in the storage unit as the position information of the vehicle 30.

An input and output unit 34 is composed of a touch panel display, a speaker, microphone, etc. The input and output unit 34 is configured to be able to input and output predetermined information such as information related to driving support by displaying characters, figures, etc. on the screen of the touch panel display or outputting sound from the speaker in accordance with the control by the ECU 35. Further, the input and output unit 34 is configured such that a user or the like of the vehicle 30 can input predetermined information to the ECU 35 by operating the touch panel display or emitting a voice toward the microphone.

The ECU 35 is composed of an information processing device such as a microcomputer including a CPU, FPGA, ROM, RAM, and the like. The ECU 35 comprehensively controls the electrical operation of each portion of the vehicle 30. The ECU 35 is configured to perform calculation using input data and data and a program stored in advance, and output the calculation result as a control command signal.

Note that, the vehicle 30 includes storage media such as a hard disk and a semiconductor memory, a storage unit including a drive device for these storage media, a sensor for detecting an object approaching the vehicle 30, and the like. The storage unit stores programs of an operating system (OS) and various applications necessary for the ECU 35 to comprehensively control the operation of each portion of the vehicle 30.

Further, the vehicle 30 is provided with a control mechanism and an operation mechanism for driving the vehicle 30. Specifically, the vehicle 30 includes a powertrain and drive wheels as a drive mechanism. The powertrain includes a power source that generates a driving force and outputs the generated driving force from an output shaft, and a power transmission mechanism that transmits the driving force output by the power source to the drive wheels.

Further, the operation mechanism is composed of a shift lever, an accelerator pedal, and the like.

In the present embodiment, the vehicle 30 travels by autonomous driving, and each portion is driven in accordance with an instruction signal under the control of the ECU 35. Under the control of the traveling lane management device 20, the ECU 35 causes the vehicle 30 to travel in the set traveling lane at the set speed.

The power supply management device 40 is connected to the power supply device 41, receives information acquired from each vehicle 30 by the power supply device 41, and controls power supply to the vehicle 30 based on the received information. The power supply management device 40 is configured using one or a plurality of computers including a CPU, FPGA, ROM, RAM, and the like.

Further, the power supply management device 40 includes a control unit 40a.

The control unit 40a comprehensively controls an operation of each unit of the power supply management device 40. The control unit 40a controls power supply to the power supply device 41 installed in each traveling lane based on the control information acquired from the traveling lane management device 20.

Here, in the present embodiment, an example case of a road 50 having three traveling lanes in which the vehicle 30 travels in the same direction and three traveling lanes in which the vehicle 30 travels in the opposite direction adjacent to the traveling lanes, a total of six traveling lanes, will be described. Specifically, the vehicle 30 travels in the same direction in each of a first traveling lane 51, a second traveling lane 52, and a third traveling lane 53. The vehicle 30 travels in the same direction in each of a fourth traveling lane 54, a fifth traveling lane 55, and a sixth traveling lane 56.

Further, in the present embodiment, normally, it is assumed that the type of the vehicle 30 traveling in each traveling lane is regulated. Specifically, the type of the vehicle 30 is regulated such that a small-sized vehicle 30 travels in the first traveling lane 51 and the fourth traveling lane 54, a medium-sized vehicle 30 travels in the second traveling lane 52 and the fifth traveling lane 55, and a large-sized vehicle 30 travels in the third traveling lane 53 and the sixth traveling lane 56. The term “normally” as used herein refers to a state in which traveling on the road 50 is not hindered by an accident, disaster, or the like. Further, the small size, medium size and large size of the vehicle 30 are classified in accordance with the weight of the vehicle 30 (including the loadable weight). Emergency vehicles are classified as, for example, large-sized vehicles. For example, in FIG. 3, the large-sized vehicle 30 is 30L, the medium-sized vehicle 30 is 30M, and the small-sized vehicle 30 is 30S.

A plurality of the power supply devices 41 is provided at preset intervals in each traveling lane. The power supply devices 41 are provided, for example, at intervals of several kilometers (km). Although FIG. 3 shows an example in which the installation area of the power supply device 41 is smaller (shorter) than that of the vehicle 30, the installation area can be made longer than the vehicle 30 or the power supply range can be adjusted.

In the present embodiment, the type of the vehicle 30 traveling in each traveling lane is normally determined. Therefore, the electric power supplied to the power supply device 41 in each traveling lane is set in accordance with the type of the vehicle 30. For example, the electric power supplied to the power supply device 41 installed in the traveling lane for the large-sized vehicle is relatively large, and the electric power supplied to the power supply device 41 installed in the traveling lane for the small-sized vehicle is relatively small. The power supply to the power supply device 41 installed in the traveling lane for the medium-sized vehicle is approximately the middle of the power supplied to the power supply devices 41 in the traveling lanes for the large-sized vehicle and the small-sized vehicle. Controlling the power supply ratio as described above supplies the electric power corresponding to the traveling vehicle 30.

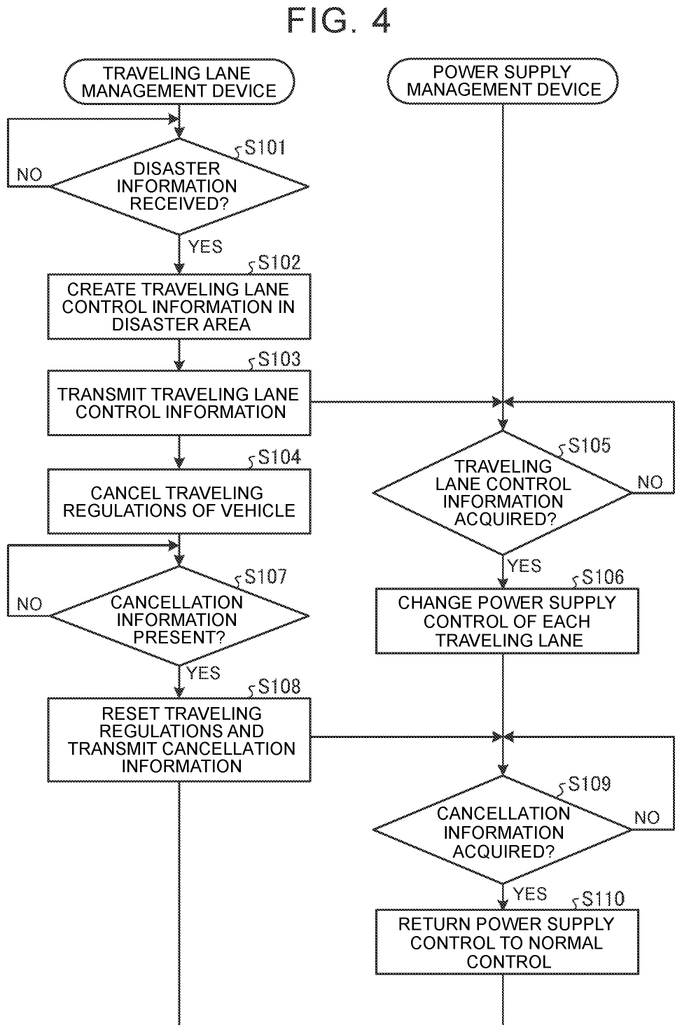

Subsequently, a traveling control process executed by the traveling control system 1 will be described with reference to FIG. 4. FIG. 4 is a sequence diagram illustrating a traveling control process executed by the traveling control system according to the embodiment.

First, the control unit 22 of the traveling lane management device 20 determines whether information related to a disaster (hereinafter referred to as disaster information) is received (step S101). The disaster information is distributed, for example, from disaster prevention centers of national and local governments. When the control unit 22 determines that the disaster information has not been received (step S101: No), the control unit 22 repeats the reception confirmation. On the other hand, when the control unit 22 determines that the disaster information has been received (step S101: Yes), the control unit 22 proceeds to step S102. Before acquiring the disaster information, the traveling lane control is assumed to be in the normal state. That is, the type of the traveling vehicle 30 is designated for each traveling lane, and the power supply ratio is also a ratio corresponding to the type of the vehicle 30 traveling in the traveling lane.

In step S102, the control information creation unit 21 creates traveling lane control information including information to cancel designation of the type of the vehicle 30 traveling in the traveling lane and the power supply ratio in the traveling lane, based on the received disaster information. The power supply ratio created here is the power supply ratio in each traveling lane after the designation is canceled. When the designation is canceled, all types of vehicles 30 travel in the traveling lanes. Therefore, the electric power supplied to all the traveling lanes is equalized. At this time, it is allowable if the power supply is equalized. However, in order to reliably supply the electric power to the large-sized vehicle 30 (30L), it is preferable to set the electric power supplied to each of the traveling lanes to be equalized in accordance with the electric power supplied to the traveling lane in which the vehicle 30L travels in the normal state.

The control unit 22 transmits the traveling lane control information created in step S102 to the power supply management device 40 (step S103). At this time, the traveling lane control information is transmitted to the power supply management device 40 that manages the power supply device 41 in the disaster area.

The control unit 22 cancels the traveling regulations by canceling the designation of the type of the vehicle 30 in the traveling lane (step S104). With this configuration, each vehicle 30 can travel in any of the traveling lanes. For example, among the first traveling lane 51, the second traveling lane 52, and the third traveling lane 53 that are shown in FIG. 3 and in which the vehicle 30 travels in the same direction, the vehicle 30 traveling in the third traveling lane 53 can also travel in the first traveling lane 51 and the second traveling lane 52 in addition to the third traveling lane 53 as the designation is canceled.

At this time, the vehicle 30 may be controlled to travel in the traveling lane assigned by the control unit 22, that is, the traveling lane in which the vehicle 30 travels while continuing autonomous driving may be controlled by the control unit 22, or the driver may drive the vehicle 30 in the designated traveling lane.

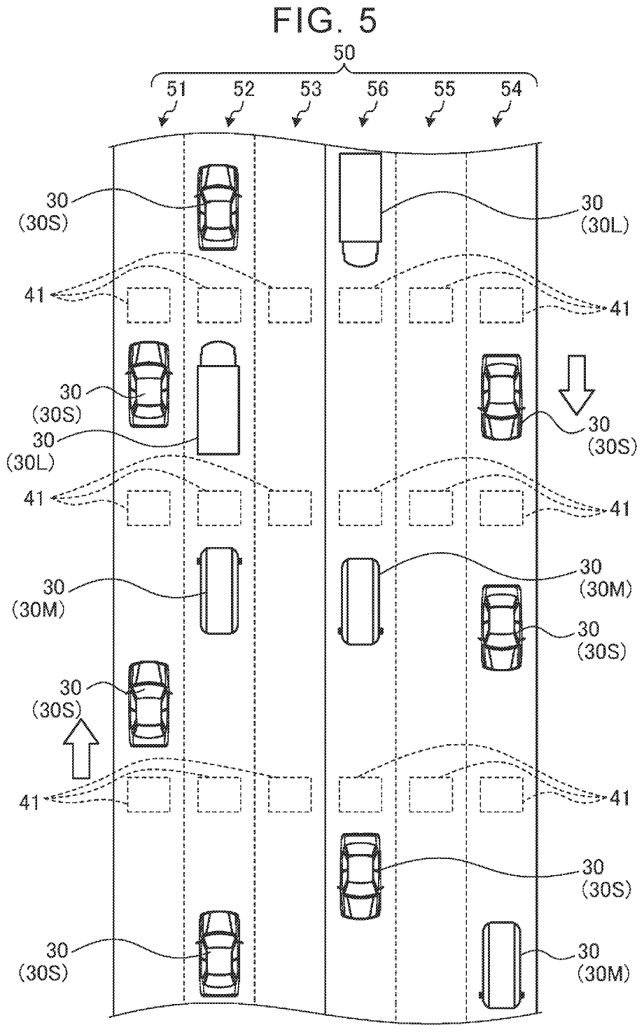

FIG. 5 is a diagram showing an example of a mode of controlling the traveling lanes in the event of a disaster in the traveling control system according to the embodiment. FIG. 5 shows a case where the third traveling lane 53 and the fifth traveling lane 55 are damaged by the disaster and the vehicle 30 cannot travel therein. When the designation is canceled from the state in which the type of the traveling vehicle is designated (see FIG. 3), each vehicle 30 (vehicles 30L, 30M, 30S) travels in each traveling lane (the first traveling lane 51, the second traveling lane 52, the fourth traveling lane 54, and the sixth traveling lane 56 herein) as shown in FIG. 5.

On the other hand, the power supply management device 40 determines whether the traveling lane control information has been received (step S105). When the control unit 40a determines that the traveling lane control information has not been received (step S105: No), the control unit 40a repeats the reception confirmation of the traveling lane control information. On the other hand, when the control unit 40a determines that the traveling lane control information has been received (step S105: Yes), the control unit 40a proceeds to step S106.

In step S106, the control unit 40a changes the power supply control of each traveling lane in accordance with the traveling lane control information. The control unit 40a equalizes the electric power supplied to each traveling lane as the designation is canceled. At this time, the electric power may not be supplied to the traveling lane in which the vehicle 30 does not travel due to the disaster.

For example, even when the traveling lanes (the third traveling lane 53 and the sixth traveling lane 56 in FIG. 3) in which the emergency vehicle 30 (vehicle 30L) travels are damaged and thus the emergency vehicle 30 cannot travel, the emergency vehicle 30 can move by traveling in another lane by executing the controls in step S104 and S106. At this time, the power supply ratios are equalized. Therefore, the battery 36 is charged regardless of the traveling lane.

After that, the control unit 22 determines whether the cancellation information for canceling the regulations due to the disaster has been received (step S107). When the control unit 22 determines that the cancellation information has not been received (step S107: No), the control unit 22 repeats the reception confirmation. On the other hand, when the control unit 22 determines that the cancellation information has been received (step S107: Yes), the control unit 22 proceeds to step S108.

In step S108, the control unit 22 resets the designation of type of the vehicle 30 and transmits the cancellation information to the power supply management device 40.

The control unit 40a determines whether the cancellation information has been received (step S109). When the control unit 40a determines that the cancellation information has not been received (step S109: No), the control unit 40a repeats the reception confirmation. On the other hand, when the control unit 40a determines that the cancellation information has been received (step S109: Yes), the control unit 40a proceeds to step S110.

In step S110, the control unit 40a returns the power supply ratio to the power supply device 41 in each traveling lane to the normal ratio.

In the present embodiment described above, the traveling lane management device 20 cancels the designation of the type of the vehicle 30 when a disaster occurs in the normal state in which the type of the traveling vehicle 30 is designated for each traveling lane. With this configuration, even when the traveling lane in which the emergency vehicle 30 travels is damaged by the disaster, it is possible to maintain movement of the emergency vehicle as the emergency vehicle 30 travels in another traveling lane. According to the present embodiment, normally, when the type of the traveling vehicle 30 is designated for the traveling lane, it is possible to maintain the traveling of the emergency vehicle in the event of a disaster or the like.

In the embodiment, an example in which the vehicle 30 travels by autonomous driving while the traveling lane in which each vehicle 30 travels and the speed at which the vehicle 30 travels are controlled by the traveling lane management device 20 has been described. However, this can be applied to the case where each vehicle 30 travels by the operation of the driver. In the case of driving by the driver, for example, in normal times, a display of the vehicle 30 displays the designation information of the traveling lane in which the own vehicle should travel, or a voice that notifies the designated traveling lane is output when the vehicle 30 travels in a traveling lane that is different from the designation. At this time, the driver operates the vehicle 30 in accordance with the instruction and travels in the predetermined traveling lane. Further, when the designation is canceled, information indicating that the designation has been canceled is output.

### Modification

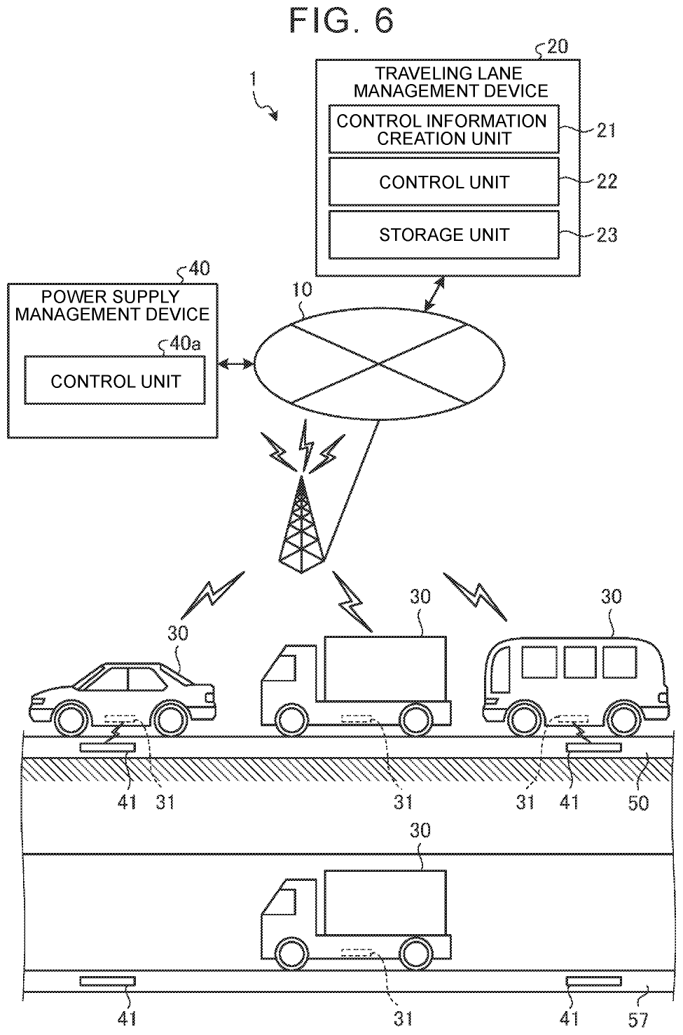

FIG. 6 is a schematic view showing a traveling control system according to a modification. A traveling control system according to the modification has the same configuration as the traveling control system 1 according to the embodiment. In the present modification, in addition to the first traveling lane 51 to the sixth traveling lane 56, an underground transportation lane 57 is provided as the traveling lane.

The underground transportation lane 57 is provided underground of the road 50, and the vehicle 30 for logistics travels therethrough. That is, normally, in the underground transportation lane 57, the traveling vehicle 30 is restricted to only the logistics vehicle. Further, also in the underground transportation lane 57, the power supply device 41 is provided to supply the electric power to the vehicle 30 traveling in the underground transportation lane 57.

In the event of a disaster, the traveling lane management device 20 causes the vehicle 30 to travel in the first traveling lane 51 to the sixth traveling lane 56 and the underground transportation lane 57, including the underground transportation lane 57, regardless of the type of the vehicle 30. At this time, the power supply ratio of each traveling lane is set such that the power supplied to each traveling lane is equalized. In addition to the vehicle 30 for transportation, the vehicle 30 that can travel in the underground transportation lane 57 may be limited to the vehicle 30 for emergency such as medical treatment.

In the present modification described above, similar to the embodiment, the traveling lane management device 20 cancels the designation of the type of the vehicle 30 when a disaster occurs in the normal state in which the type of the traveling vehicle 30 is designated for each traveling lane. With this configuration, even when the traveling lane in which the emergency vehicle 30 travels is damaged by the disaster, it is possible to maintain movement of the emergency vehicle as the emergency vehicle 30 travels in another traveling lane. According to the present modification, normally, when the type of the traveling vehicle 30 is designated for the traveling lane, it is possible to maintain traveling of the emergency vehicle in the event of a disaster or the like.

### Recoding Medium

According to the embodiment, a program capable of executing a processing method by the traveling control system can be recorded in the recording medium that is readable by a computer or other machines or devices (hereinafter referred to as “computer or the like”). The computer or the like functions as the control units of a disaster specification system as the computer or the like is caused to read the program stored in the recording medium and execute the program. Here, the recording medium that is readable by the computer or the like means a non-transitory recording medium that can accumulate information such as data or programs through electrical, magnetic, optical, mechanical, or chemical action and read the information from the computer or the like. Examples of the recording medium removable from the computer among the recording media above include, for example, a flexible disk, a magneto-optical disk, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. In addition, examples of the recording medium fixed to the computer include a hard disk and a read-only memory (ROM). Further, a solid state drive (SSD) can be used as the recording medium removable from the computer or as the recording medium fixed to the computer.

### Other Embodiment

In the traveling control system according to the embodiment, the “unit” can be read as a “circuit” or the like. For example, the communication unit can be read as a communication circuit.

The program to be executed by the traveling control system according to the embodiment may be configured to be stored in a computer connected to a network such as the Internet and provided through downloading via the network.

Further effects and modifications can be easily derived by those skilled in the art. The broader aspects of the present disclosure are not limited to the particular details and representative embodiments shown and described above. Accordingly, various modifications may be made without departing from the scope of the general inventive concept defined by the appended claims and their equivalents.

What is claimed is:

1. A traveling control device, comprising a processor that cancels designation of a type of a vehicle that travels in each of a plurality of traveling lanes in which the vehicle travels in the same direction and for which the type of the vehicle that travels in each of the traveling lanes is designated, when information related to a disaster is acquired.

2. The traveling control device according to claim 1, wherein when the information related to a disaster is acquired, the processor cancels the designation of the type of the vehicle in the traveling lanes including an underground transportation lane.

3. The traveling control device according to claim 1, wherein the processor controls the traveling lane and a speed of the vehicle.

4. The traveling control device according to claim 1, wherein the processor transmits, to the vehicle, information for designating the traveling lane in which the vehicle travels, and when the information related to a disaster is acquired, the processor transmits, to the vehicle, information for canceling the designation.

5. The traveling control device according to claim 1, wherein:
a power supply device that supplies electric power to the vehicle is installed in each of the traveling lanes; and
the processor transmits a power supply ratio in each of the traveling lanes to a power supply management device that manages the power supply device.

6. The traveling control device according to claim 5, wherein when the type of the vehicle is designated for the traveling lane, the processor sets the power supply ratio corresponding to the type of the vehicle designated for each of the traveling lanes, and when the designation of the type is canceled, the processor sets the power supply ratio that is equal to each of the traveling lanes.

7. A traveling control program that causes a processor to execute cancellation of a designation of a type of a vehicle that travels in each of a plurality of traveling lanes in which the vehicle travels in the same direction and for which the type of the vehicle that travels in each of the traveling lanes is designated, when information related to a disaster is acquired.

8. The traveling control program according to claim 7, causing the processor to execute cancellation of the designation of the type of the vehicle in the traveling lanes including an underground transportation lane when the information related to a disaster is acquired.

9. The traveling control program according to claim 7, causing the processor to execute control of the traveling lane and a speed of the vehicle.

10. The traveling control program according to claim 7, causing the processor to execute:
transmission of, to the vehicle, information for designating the traveling lane in which the vehicle travels; and
transmission of, to the vehicle, information for cancelling the designation when the information related to a disaster is acquired.

11. The traveling control program according to claim 7, wherein:
a power supply device that supplies electric power to the vehicle is installed in each of the traveling lanes; and
the traveling control program causes the processor to transmit a power supply ratio in each of the traveling lanes to a power supply management device that manages the power supply device.

12. The traveling control program according to claim 11, causing the processor to execute setting of the power supply ratio corresponding to the type of the vehicle designated in each of the traveling lanes when the type of the vehicle is designated for the traveling lane, and setting of the power supply ratio that is equal to each of the traveling lanes when the designation of the type is canceled.

13. A traveling control system, comprising:
a plurality of traveling lanes in which a vehicle travels in the same direction and for which a type of the vehicle that travels in each of the traveling lanes is designated; and
a traveling control device including a first processor that cancels, for the traveling lanes, the designation of the type of the vehicle traveling in each of the traveling lanes when information related to a disaster is acquired.

14. The traveling control system according to claim 13, wherein when the first processor acquires the information related to a disaster, the first processor cancels the designation of the type of the vehicle in the traveling lanes including an underground transportation lane.

15. The traveling control system according to claim 13, wherein the first processor controls the traveling lane and a speed of the vehicle.

16. The traveling control system according to claim 13, wherein the first processor transmits, to the vehicle, information for designating the traveling lane in which the vehicle travels, and when the information relating to a disaster is acquired, the first processor transmits, to the vehicle, information for canceling the designation.

17. The traveling control system according to claim 13, further comprising:
a power supply device that is installed in each of the traveling lanes and that supplies electric power to the vehicle; and
a power supply control device including a second processor that controls power supply to the power supply device, wherein the first processor transmits a power supply ratio in each of the traveling lanes to a power supply management device that manages the power supply device.

18. The traveling control system according to claim 17, wherein when the type of the vehicle is designated for the traveling lane, the first processor sets the power supply ratio corresponding to the type of the vehicle designated for each of the traveling lanes, and when the designation of the type is canceled, the first processor sets the power supply ratio that is equal to each of the traveling lanes.

19. The traveling control system according to claim 17, wherein the second processor controls power supply to the power supply device installed in each of the traveling lanes based on the power supply ratio that is set.

20. The traveling control system according to claim 17, wherein the power supply device transmits a power supply signal to the vehicle by wireless communication.
